(19) United States
(12) Patent Application Publication
(10) Pub. No.: US 2019/0161270 A1
(43) Pub. Date: May 30, 2019

(54) SINGLE SERVE CAPSULE WITH A CALENDERED FIBROUS MATERIAL

(71) Applicant: K-FEE SYSTEM GMBH, Bergisch Gladbach (DE)

(72) Inventors: Günter Empl, Bergisch Gladbach (DE); Marco Hanisch, Overath (DE)

(21) Appl. No.: 16/263,167

(22) Filed: Jan. 31, 2019

Related U.S. Application Data
(63) Continuation of application No. 15/318,130, filed on Dec. 12, 2016, now abandoned.

(30) Foreign Application Priority Data
Jun. 12, 2014 (DE) 102014108260.5
Dec. 15, 2014 (DE) 102014118585.4

(51) Int. Cl. B65D 85/804; B65D 65/46

(52) U.S. Cl. CPC B65D 85/8043; B65D 65/466

(57) ABSTRACT

The invention proposes a portion capsule for producing a beverage, having a capsule body with a capsule base and a filling side, with a cavity for accommodating a pulverulent or liquid beverage base being formed between the capsule base and the filling side, with a filter element being arranged between the beverage base and the capsule base, and with the fitter element comprising a non-woven which is arranged in the region of the capsule base.

The present invention relates to a portion capsule for producing a beverage, having a capsule body with a capsule base and a filling side, with a cavity for accommodating a pulverulent or liquid beverage base being formed between the capsule base and the filling side, and with a filter element being arranged between the beverage base and the capsule base.

Portion capsules of this kind are generally known from the prior art. By way of example, documents EP 1792850 B1, EP 1344722 A1, US 2003/0172813 A1 and WO 2012/038063 disclose portion capsules of this generic type for preparing coffee and espresso.

Portion capsules of this kind for producing a beverage are preferably in the form of a truncated cone or cylinder and are produced, for example, from a thermoformed plastic film or using a plastic injection-moulding process. The said portion capsules usually have an open filling side with a collar edge onto which a cover film or foil is sealed or adhesively bonded, and a closed capsule base, with a particle screen which is supported against the capsule base being arranged between the beverage base and the capsule base. These filter elements are either injection-moulded from a thermoplastic or are thermoformed or stamped from a plastic film or produced from a non-woven or felt.

For the purpose of preparing a coffee beverage, the portion capsule is inserted into a brewing chamber of a preparation appliance. After or during the closing process of the brewing chamber, the capsule is preferably opened on its closed base side by means of an opening mandrel which is arranged in the brewing chamber and, after the brewing chamber is sealed off, the filling side of the portion capsule, which filling side is sealed off by a sealing film or foil, is tapped by means of a puncturing means. Preparation liquid, preferably hot water, is then delivered into the portion capsule under pressure. The preparation liquid flows through the beverage base and extracts and/or dissolves the substances, which are required for producing the beverage, from the beverage base. For the purpose of preparing an espresso, for example a brewing water pressure of up to 20 bar acts on the coffee powder for the purpose of extracting the essential oils. This pressure also acts on the particle screen which is situated between the coffee powder and the capsule base and in front of the punctured capsule outlet.

A disadvantage of the filter elements known from the prior art is either the complicated production of the said filter elements or the comparatively low mechanical stability of the said filter elements.

The object of the present invention was therefore to provide a portion capsule having a filter arrangement, which portion capsule is less expensive to manufacture in comparison to the prior art and in which the disadvantages described in connection with the prior art are avoided at the same time.

This object is achieved by a portion capsule for producing a beverage, having a capsule body with a capsule base and a filling side, with a cavity for accommodating a pulverulent or liquid beverage base being formed between the capsule base and the filling side, and with a filter element being arranged between the beverage base and the capsule base, with the filter element comprising a spot- and/or structure-calendered material which is produced from fibres.

In comparison to the prior art, the portion capsule according to the invention has the advantage that a simple and cost-effective filter element which has a high degree of mechanical stability is used, so that it does not tear further even when it is tapped and/or pierced by a tapping means. A complicated plastic injection-moulding process or a thermoforming or stamping process for producing the fitter elements can therefore be saved. The production costs are therefore considerably lowered. In addition, a supporting structure is not required, but may be present, since the filter element s preferably supported directly on the capsule base. In addition, a filter element has the advantage over the plastic filters known from the prior art that it has a considerably larger liquid inlet area. Furthermore, transverse flow of liquid (parallel to the plane of main extent of the filter plane) is made possible, as a result of which improved mixing and outflow behaviour is achieved. It has also been found that the risk of the screens becoming blocked is considerably reduced or virtually eliminated when a filter element which is produced from fibres is used. Surprisingly, the filter element has proven to be resistant to blockage both in the case of beverage preparation with a preparation liquid which is under a comparatively low pressure and in the case of beverage preparation with a preparation liquid which is under a comparatively high pressure. Furthermore, a transverse flow of liquid in the filter element is always reliably maintained at least in sections and outflow of the liquids entering the filter element to an outflow opening is always reliably ensured.

The portion capsule within the meaning of the present invention comprises a preferably hermetically sealed portion capsule. This means that the beverage or food product base, for example coffee powder, soup powder or tea, located in the portion capsule is sealed off from the environment in a substantially aroma-tight manner before the extraction process. The tea can be provided in the form of powder, granules, fine cuts and/or whole leaves/stalks.

However, the portion capsule does not have to be hermetically sealed, but rather can also be provided in a hermetically sealed package prior to use, the said package then being opened, for example manually, and/or any openings which may be present being covered by a film or foil which is removed or pierced before the beverage is produced.

A material which is produced from fibres is any material which has fibres as the precursor. These fibres can be ordered or unordered. The fibres can be connected to one another mechanically or by a cohesive connection. By way of example, the fibres can be spun or connected to one another by felts. Accordingly, the material from which the filter element is produced is preferably a felt and/or a non-woven.

The fibres may be, for example, plastic fibres, natural fibres, paper fibres or paper-like fibres. Different fibre materials can be blended with one another. By way of example, natural fibres, paper fibres or paper-like fibres can have a plastic fibre component, and vice versa.

According to the invention, the fibre material is spot- and/or structure-calendered. Within the meaning of the invention, spot- and/or structure-calendered means that the fibres are connected to one another, in particular welded, at least at the surfaces of the non-woven material by a thermal calendering process at points and/or in accordance with a specific structure, for example with two, in particular, intersecting lines. To this end, the fibre material is routed, for example, through heated rollers, with at least one roller having raised portions. The fibres connect/fuse with one another at least at these raised portions. As a result, the fibre material has a high degree of mechanical stability. A structure is, for example, one or more lines which are arranged, for example, at an angle, in particular a right angle, or parallel in relation to one another. However, a structure can also be a circle or another geometric shape. The points or structures are preferably arranged in accordance with a specific recurring pattern, with the individual structures being provided equidistantly in relation to one another. A filter element with connection of the layers with intersecting lines provides a particularly high degree of resistance to tearing by a puncturing mandrel, in particular when the lines intersect in the puncturing region of a puncturing mandrel.

The fibre material preferably has a large number of recesses which are particularly preferably provided in a regular pattern and/or equidistantly.

According to a further preferred embodiment of the present invention, provision is made for the non-woven to comprise a non-woven material which is produced from plastic fibres, in particular fine plastic fibres, for example fine polyester fibres, and, in particular, is a random fibre non-woven and/or a fibre-oriented non-woven. The non-woven preferably has a mass per unit area (also called the grammage or the basis weight) of between 40 and 250 grams per square metre, particularly preferably of between 80 and 140 grams per square metre, and very particularly preferably of between 110 and 130 grams per square metre. The filter element or the non-woven preferably has a thickness of between 0.2 and 2.0 millimetres, particularly preferably of between 0.3 and 0.6 millimetres, and very particularly preferably of substantially 0.32 millimetres. The non-woven is formed in such a way that air permeability of the non-woven is preferably between 100 and 3000 l/(m²s), particularly preferably between 1500 and 2500 l/(m²s), and very particularly preferably substantially 2000 l/(m²s) at a pressure of 100 pascal. It has surprisingly and unforeseeably been found that optimum results in terms of extraction efficiency, mixing and outflow behaviour and also blockage resistance can be achieved with non-wovens of this kind and that the “crema” is formed in spite of this. The fibres can comprise one or more substances. The said substance/substances may be a fibre blend. Fibres which are composed of polyester are preferably provided.

According to a further embodiment of the present invention, the filter element has a felt structure. The said felt structure is, in particular, a needle felt structure. The filter element preferably consists of at least a felt structure and a support structure, in particular a woven structure, with the felt structure, at least a subsection of the volume, particularly preferably comprising the support structure. The felt structure preferably extends over the entire cross section of the support structure, but particularly preferably only over a subregion of the height. The felt structure is preferably connected to the support structure in an interlocking, force-fitting and/or cohesive manner. The filter element preferably has two or more felt structures which are preferably separated from one another by the support structure or butt against one another within the support structure. The thickness of the two felt structures can be the same or different. A felt structure which faces the beverage base, in particular the coffee powder or tea, is preferably thinner than the felt structure which faces the capsule base, or vice versa. The surface of the felt structure is preferably treated, for example thermally treated, in order to fix, for example, loose fibres.

A fitter element with a felt structure has the advantage that no “crema” is formed on a coffee, espresso or the like, and that no bubbles are formed on a tea.

A filter element which has a support structure, in particular a woven structure, and a felt structure is produced, for example, by a woven structure comprising longitudinal and transverse threads being provided. In order to construct a felt, in particular a needle felt, fibre units of 0.8-7 dtex are preferably selected. The individual fibres are connected to one another to form a felt and/or are anchored in the support structure preferably by the needling production process. In this case, needles with barbs are inserted into and pulled out of the prelaid fibre packet at high speed. On account of the barbs, the fibres are interwoven with one another and/or with the support woven by means of a large number of loops which are produced.

The support element having one or more felt structures preferably has a mass per unit area (also called the grammage or the basis weight) of between 100 and 1500 grams per square metre, particularly preferably of between 200 and 650 grams per square metre, and very particularly preferably of substantially 150-250 grams per square metre for producing tea, but also for coffee, espresso and the like, and 600-700 grams per square metre for producing coffee, espresso or the like, but also for tea. The grammage is very particularly preferably 1000-1300 grams per square metre for producing coffee, espresso or the like, but also for tea. The filter element or the non-woven preferably has a thickness of between 0.4 and 5 millimetres, particularly preferably of between 1.1 and 3.0 millimetres. The thickness is very particularly preferably 1.2-1.4 millimetres for producing tea and 2.6-3.0 for producing coffee.

The filter element is preferably provided with several layers. These layers can lie loosely one on the other or be connected to one another at least locally. The layers are preferably produced separately from one another and then preferably connected to one another or, for example, provided in one piece and then folded. The layers are preferably connected to one another by cohesive connection and, in particular, only locally, for example along one or more, in particular narrow, strips. An only local connection between two layers has the advantage that the layers can move in relation to one another at least in sections. The layers of the filter element can be identical or different from one another. At least one, preferably each, layer of the fitter element is preferably spot- and/or structure-calendered. If only one layer is spot- and/or structure-calendered, the said layer preferably faces the capsule wall or the capsule cover.

Before being inserted into the portion capsule, the filter element is preferably separated, in particular stamped out, from a strip.

The filter element is preferably arranged on the base of the capsule such that it bears against as large an area as possible. The filter element can be inserted only into the capsule. The filter element is particularly preferably connected, in particular cohesively connected, to the base, in particular sealed to the base, in particular by ultrasound, before the capsule body is filled with the beverage base. The cohesive connection is made. In particular, along a circular ring. The filter element is particularly preferably stretched before it is attached to the capsule, in particular to the capsule base, in order to improve contact with the base.

When the capsule is opened by a perforation means, it is advantageous when the said perforation means moves the filter element away from the capsule base at least partially and/or in sections and in the process stretches or additionally stretches the said filter element. In the process, the perforation means can enter and/or penetrate the filter element. The non-woven is preferably larger than the capsule base on which it rests, and therefore the filter element protrudes, for example, to a certain extent at the edge.

The capsule body is preferably in the form of a truncated cone or cylinder and is, for example, produced from plastic, a natural material and/or a biologically degradable material comprising a thermoformed plastic film or using a plastic injection-moulding process. The capsule body preferably has, on the filling side, a collar edge onto which a cover film or foil is sealed or adhesively bonded. As an alternative, it is feasible for the capsule body and a capsule cover to be connected to one another by means of a mechanical method. The base of the portion capsule is preferably closed and is preferably first perforated in the brewing chamber by means of a perforation means for producing an outflow opening, the said perforation means acting on the portion capsule base from the outside. However, another feasible alternative is for the base of the portion capsule to already be provided with an outlet opening at the factory, the said outlet opening preferably being sealed off by means of a sealing film or foil. The sealing film or foil can be perforated, for example, by means of the perforation means or can be pulled off from the capsule base by hand. The filter non-woven spans this outlet opening. The sealing film or foil is preferably a plastic film which has at least one barrier layer, for example a metal layer, in particular an aluminium layer. The plastic film preferably has a “peel-off layer” on its side which faces the capsule, in order to be able to remove the plastic film from the capsule base with comparative ease.

The outlet opening is preferably provided in such a size that it can accommodate a perforation means, which may be present, in a contact-free manner. The outlet opening is particularly preferably provided in such a size that it exhibits no appreciable pressure loss when the ready beverage flows out, in particular that there is no appreciable swirling of the ready beverage, which could lead to air entering the beverage and therefore to the formation of foam. This embodiment is suitable both for producing tea and coffee which is not intended to have any crema or to have only a small amount of crema.

According to a further preferred embodiment of the present invention, provision is made for the filter element to be elastic and to be arranged and/or attached, at least in its edge region, in the region of the capsule base. When the capsule base is pierced by an external perforation means, the filter element can, when contact is made with the perforation means, yield or be stretched on account of its elasticity. This eliminates the risk of the filter element being destroyed by the perforation means and beverage substance being washed out of the portion capsule without being filtered. A fixed spacing between the filter element and the capsule base, as is known from the prior art, is not necessary, but can be present, since this distance is automatically created by the perforation means. Furthermore, a collection tank for the beverage liquid which passes through the filter element is produced beneath the filter element in this way.

The beverage base is preferably at least temporarily compressed to a certain extent when the portion capsule is perforated.

According to a further preferred embodiment of the present invention, provision is made for the filter element to be stretched, tapped and/or perforated by the perforation means.

According to a further embodiment of the present invention, provision is made for the edge region to extend at least partially along a side wall region of the capsule body, with the side wall region extending between the filling side and the capsule base.

According to a further preferred embodiment of the present invention, provision is made for the filter element to completely or only partially cover the capsule base.

According to a further embodiment of the present invention, provision is made for the fitter element to be attached to the capsule base in an edge region of the capsule base, and/or for the filter element to be attached to the side wall region in an edge region of the filter element.

This advantageously prevents the filter element from slipping down and increases the sealing effect between the capsule body and the filter element, but with it further being made possible to lift off the filter element in its central region at the same time. In this case, the filter element is preferably elastic.

According to a further embodiment of the present invention, provision is made for the capsule base to have a protrusion in a direction opposing the filling side. The protrusion advantageously serves to accommodate the perforation means, so that when the perforation means punctures the capsule base, the capsule base is perforated in the region of the protrusion but the perforation means then remains in the cavity in the protrusion. This prevents perforation of the filter element and/or perforation is reduced. In particular, it is not necessary for the filter element to be lifted off by the perforation means in this embodiment. Nevertheless, the filter element can be designed to be lifted off by the perforation means in order to preclude accidental perforation in any case.

According to a further embodiment of the present invention, provision is made for the filter element to lift off from the capsule base only in a central region and to continue to rest on the capsule base or remain attached to the capsule base in the edge region of the capsule base. This advantageously prevents the filter element from slipping and increases the sealing effect between the capsule body and the filter element, but with it further being made possible to lift off the filter element in its central region at the same time. In this case, the filter element is preferably elastic.

A further subject matter of the present invention is the use of a portion capsule for producing a beverage, preferably for producing a coffee, cocoa, tea, instant and/or milk beverage and other beverage preparations.

The capsule preferably does not have a filter element when a cocoa, milk or instant beverage is produced.

The statements made in relation to one subject matter of the present invention apply to the other subjects in equal measure, and vice versa.

Exemplary embodiments of the invention are illustrated in the figures and explained in greater detail in the following description. The figures are described merely by way of example and do not restrict the general concept of the invention. The description applies to all the subjects of the present invention in equal measure.

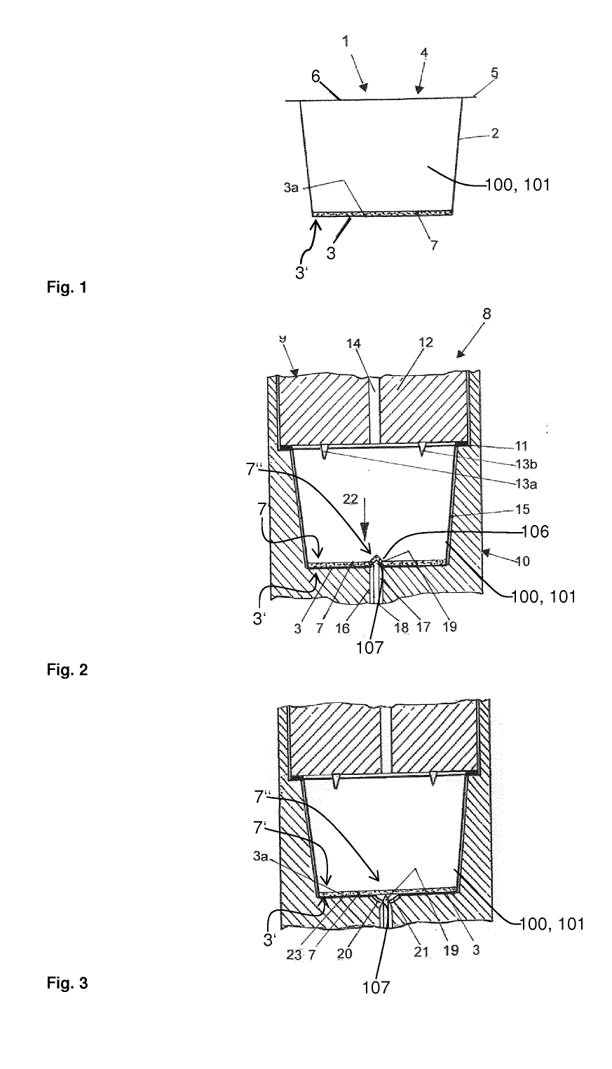

FIG. 1 shows a longitudinal section through a portion capsule according to a first embodiment of the present invention, which portion capsule is designed for the purpose of preparing an espresso.

FIG. 2 shows a longitudinal section through a portion capsule, which is situated in a closed brewing chamber, according to the first embodiment of the present invention.

FIG. 3 shows a longitudinal section through a portion capsule, which is situated in a closed brewing chamber, according to a second exemplary embodiment of the present invention.

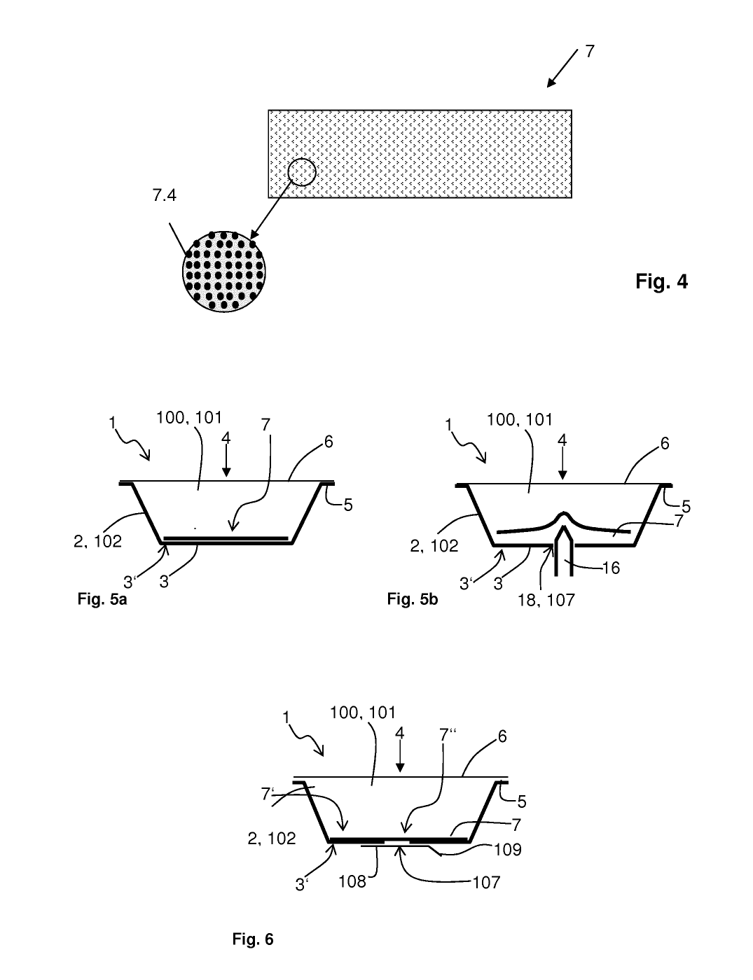

FIG. 4 shows a spot-calendered non-woven.

FIGS. 5a, 5b show schematic sectional views through a portion capsule according to one preferred embodiment of the present invention.

FIG. 6 shows a schematic sectional view of a portion capsule according to a further preferred embodiment of the present invention.

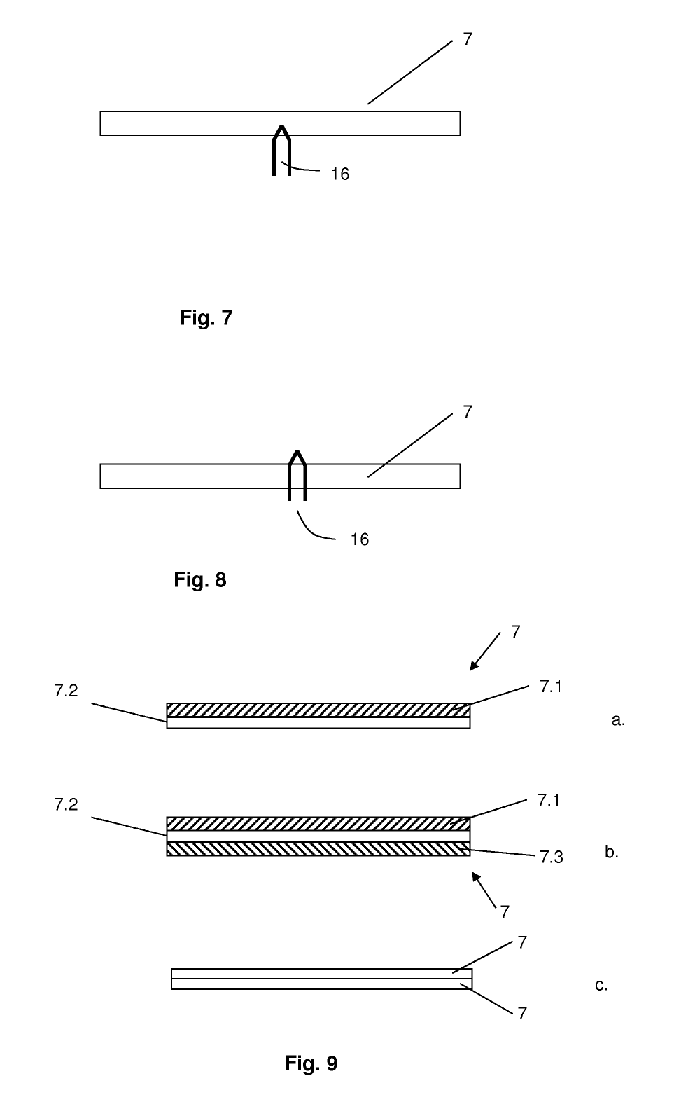

FIG. 7 shows a perforation means which enters the filter element.

FIG. 8 shows a perforation means which penetrates the filter element.

FIGS. 9a-c show different embodiments of the filter element comprising felt, in particular needle felt.

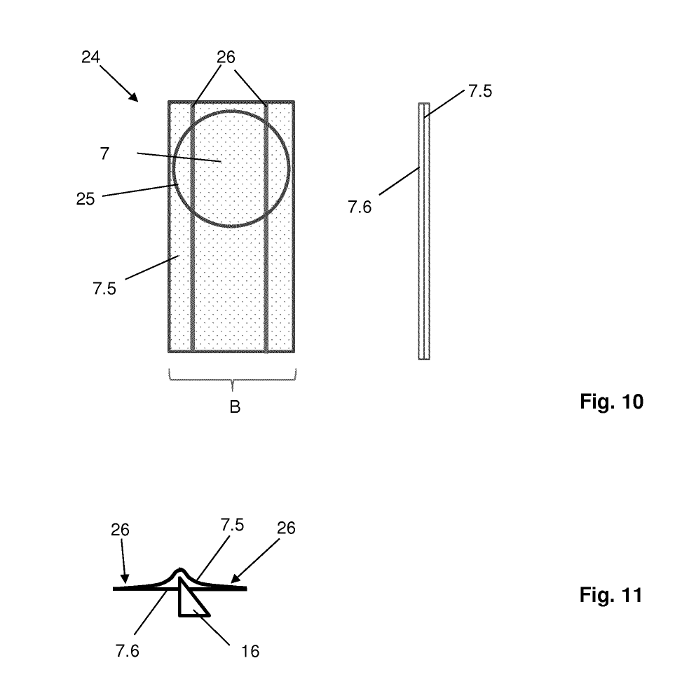

FIG. 10 shows a filter element comprising two layers.

FIG. 11 shows the filter element according to FIG. 10 when the capsule is tapped by a perforation means.

In the various figures, identical parts are always provided with the same reference symbols and therefore also will be generally cited or mentioned only once in each case.

FIG. 1 illustrates a first embodiment of the portion capsule 1 according to the invention. The portion capsule 1 comprises a capsule body 2 in the form of a truncated cone, having a closed capsule base 3 and having a collar edge 5 which is arranged on the filling side 4 of the said capsule body and to which a cover film or foil 6 is welded or adhesively bonded. Therefore, a cavity 100, which is preferably sealed off in an air- and aroma-tight manner, is formed between the capsule base 3 and the cover film or foil 6, the said cavity being filled with a pulverulent or granular or leaf-like beverage substance 101. In this case, the beverage substance 101 comprises, for example, coffee, cocoa, tea and/or milk powder (or granules). The tea can also be provided in the form of coarse or fine cuts or in the form of whole leaves or fruits or pieces of fruit. A filter element 7 comprising a fibre material is arranged on the inner side 3a of the closed capsule body base 3, that is to say within the cavity 100. The filter element 7 is situated either loosely on the inner side 3a of the capsule base 3 or is firmly, that is to say preferably cohesively, connected to the inner side 3a of the capsule body base 3. In the second variant, the filter element 7 is attached in a cohesive manner to the capsule base 3, in particular only in an edge region 3′ of the capsule base 3. The filter element can, for example, be a non-woven and/or comprise a felt structure. The non-woven preferably comprises a non-woven material which is produced from fine polyester fibres. The fibres are particularly preferably thermally spot-connected to one another by means of a calender. For example a large number of extruded polyester fibres are arranged one on the other and next to one another and then spot- and/or structure-calendered by means of heated rollers. The non-woven comprises random fibre and/or fibre-oriented non-woven material. The non-woven preferably has a mass per unit area (also called the grammage or the basis weight) of between 40 and 250 grams per square metre, particularly preferably of between 80 and 140 grams per square metre, and very particularly preferably between 110 and 130 grams per square metre. The filter element or the non-woven preferably has a thickness of between 0.2 and 2 millimetres, particularly preferably of between 0.3 and 0.6 millimetres, and very particularly preferably of substantially 0.32 millimetres. The non-woven is formed in such a way that air permeability of the non-woven is preferably between 100 and 3000 l/(m²s), particularly preferably between 1500 and 2500 l/(m²s), and very particularly preferably substantially 2000 l/(m²s), at a pressure of 100 pascal. The non-woven is further formed in such a way that the breaking strength is between 100 and 400 newtons per 5 centimetres, particularly preferably 200 and 300 newtons per 5 centimetres, particularly preferably substantially 220-270 newtons per 5 centimetres, in the longitudinal direction, and between 50 and 350 newtons per 5 centimetres, preferably between 100 and 250 newtons per 5 centimetres, particularly preferably substantially 120-200 newtons per 5 centimetres, in the transverse direction, with the breaking extension being between 20% and 60%, preferably between 30% and 50%, particularly preferably substantially 40 percent, in the longitudinal direction, and between 30% and 70%, preferably between 40% and 60%, particularly preferably substantially 50 percent, in the transverse direction. In spite of these very good mechanical properties, the non-woven has very good throughflow rates and filter properties.

FIG. 2 illustrates a portion capsule 1 according to the first embodiment, which is illustrated in FIG. 1, of the present invention, with the portion capsule 1 in FIG. 2 being arranged in a closed brewing chamber 8. The brewing chamber 8 consists of a first brewing chamber element 9 and a second brewing chamber element 10, with the first brewing chamber element 9 being provided for the purpose of inserting the portion capsule 1 such that it can move in relation to the second brewing chamber element 10, or vice versa. A seal 11 is arranged between the two brewing chamber elements 9, 10. The first brewing chamber element 9 substantially consists of a closing piston 12 with puncturing elements 13a, 13b for opening the cover film or foil 6 of the portion capsule 1, a preparation liquid supply means 14 and the seal 11. The second brewing chamber element 10 substantially consists of a brewing chamber bell 15 which partially surrounds the portion capsule 1 and has an opening mandrel 16 which is arranged on the base of the brewing chamber bell 15 and is provided with discharge grooves 17, and a beverage discharge means 18. For the purpose of accommodating the portion capsule 1, the brewing chamber 8 is in an open state (not illustrated), in which the first and the second brewing chamber element 9, 10 are spaced apart from one another in order to ensure supply of the portion capsule 1, and in the illustrated closed state, in which a preparation process for producing a beverage using the portion capsule 1 can be carried out. In the closed state, the brewing chamber 8 is sealed off in a sealed manner. When the brewing chamber 8 is moved from the open state to the depicted closed state, the cover film or foil 6 is pierced by the puncturing elements 13a, 13b, so that preparation liquid, in particular hot brewing water, passes through the preparation liquid supply means 14 under pressure and into the cavity 100 in the portion capsule 1. Furthermore, when the brewing chamber 8 is closed, the capsule base 3 is perforated by the perforation means, which is in the form of an opening mandrel 16, and therefore an outlet opening 107 is produced in the portion capsule 1, it being possible for the produced beverage liquid to leave the portion capsule 1 in the direction of the beverage discharge means 18 through the said outlet opening. In order to assist delivery of the beverage liquid, the opening mandrel 16 is preferably provided with the discharge grooves 17 on its casing surface. In the illustration, the base 3 of the portion capsule 1, which is located in the brewing chamber 9, 10, is pierced by the opening mandrel 16 of the second brewing chamber element, but the filter element 7, which is situated above the puncturing point, is slightly raised by the puncturing spike 19 of the opening mandrel 16 but not pierced. This is achieved, in particular, by the central region 7″ not being cohesively connected to the capsule base 3 but the filter element 7 being cohesively connected to the capsule base 3 only in the edge region 3′ of the capsule base 3, so that it is raised only from the capsule base 3 as a result of the mechanical contact with the spike of the opening mandrel 16 and therefore remains intact (that is to say is for example tapped but not destroyed by the opening mandrel 16). The capsule base 3 and the filter element 7 remain in contact with one another and, in particular, cohesively connected to one another in the edge region 3′ of the capsule base 3 and in the edge region 7′ of the filter element 7, and therefore no beverage substance 101 enters the beverage discharge means 18 around the filter element 7.

FIG. 3 illustrates a portion capsule 1 according to a second embodiment of the present invention, with the second embodiment substantially resembling the first embodiment, which is illustrated in FIG. 2, and likewise illustrating the portion capsule 1 in a closed brewing chamber 8. However, in contrast to the first embodiment, the portion capsule base 3 has, in the puncturing region of the opening mandrel 16, a protrusion 21 which is directed towards a recess 20 in the brewing chamber base 3a (the protrusion 21 is therefore directed in a direction which opposes the filling side 4) and which the opening mandrel 16 enters, without piercing the filter element 7 in the process. Therefore, it is, in particular, not necessary to lift off the filter element 7 from the capsule base 3. In order to produce the beverage, the brewing chamber 8 is closed again after the portion capsule 1 is inserted into the brewing chamber 8. During the closing process, the cover film or foil 6 of the portion capsule 1 is perforated by means of the puncturing means 13a, 13b and, after the first and the second brewing chamber element 9, 10 are brought together and sealed (by means of the seal 11), brewing water is made available via the liquid inlet 6. The opening mandrel 16 likewise makes an opening in the base 3 of the portion capsule 1 during the closing process of the brewing chamber. The thickness and the tear strength of the filter element 7, which is situated above the puncturing point, are matched to the penetration depth of the puncturing spike 19 of the opening mandrel 16, and therefore the filter element 7 is preferably not pierced. As an alternative, the filter element 7 is situated above the protrusion 21 of the capsule base 3, which protrusion is situated in the recess in the brewing bell base 23, and the opening mandrel 16 enters only the protrusion 21 of the capsule base 3 and does not reach the filter element 7. The liquid, for example hot water when coffee is being produced, then flows into the capsule 1. In the capsule, this liquid flows through the beverage base 101 and extracts and/or dissolves the substances, which are required to produce the beverage, from the beverage base 101. The flow of the liquid in the beverage base 101 is illustrated by reference symbol 22. The resulting beverage then flows through the filter element 7 which is arranged between the beverage base 101 and the capsule base 3, this preventing constituents of the beverage base 101 entering the resulting beverage in particulate form and further entering a collection vessel, for example a cup or pot, via the opening made in the capsule base 3 by the opening mandrel 16 and via the discharge grooves 17 in the opening mandrel 16.

FIG. 4 shows the filter element 7 which, according to the invention, is provided from a spot-calendered fibre material, for example from a spot-calendered non-woven or a spot-calendered felt. As can be seen in the said figure, in particular in the magnified portion, the fibre material therefore has a structure with recesses 7.4. These recesses are preferably provided in accordance with a uniform pattern and/or equidistantly. The unordered fibres from which the fibre material is constructed are connected, in particular welded, to one another at least in the region of the recesses. The recess in the fibre material is produced by the said fibre material being routed between two rollers of which at least one roller is heated, and at least one roller, preferably a heated roller, has raised portions which stamp the pattern of the recesses into the fibre material. The fibre material is preferably compressed between the rollers. Instead of the spots, structures can also be at least partially stamped into the material. Structures of this kind are, for example, lines which can be straight or curved and which are provided parallel and/or at an angle in relation to one another. Other examples of structures are circles, ovals, rectangles and/or squares. These structures can be provided on rollers, and therefore they recur at regular intervals in the material.

FIGS. 5a and 5b illustrate schematic sectional views through a portion capsule 1 according to a further embodiment of the present invention. This embodiment substantially resembles the first embodiment, which is illustrated in FIGS. 1 and 2, with the filter element 7 being elastic. FIG. 5a illustrates the portion capsule 1 in its starting position, while FIG. 5b illustrates the said portion capsule in a state in which it is perforated by the perforation means 16 (the portion capsule 1 is located in a brewing chamber 8, not illustrated further, in FIG. 5b). When mechanical contact is made with the perforation means 16, the filter element 7 is, in its central region 7″, stretched in the direction of the inlet side 4 on account of the elastic design of the filter element 7, without being torn by the perforation means 16, with at least partial perforation of the filter element being possible. The filter element 7′ remains firmly or cohesively connected to the capsule base 3 in the edge region of the capsule base 3′, and therefore no beverage substance 101 passes from the cavity 100 in the direction of the outlet opening 107, which is produced by the perforation means 16, past the filter element 7. The connection is preferably made by sealing, in particular using ultrasound, particularly preferably along a circular ring.

FIG. 8 is a schematic sectional view through a portion capsule 1 according to a further embodiment of the present invention. This embodiment substantially resembles the first embodiment, which is illustrated in FIG. 1, with the portion capsules 1 of the present embodiment being equipped with a permanent outlet opening 107 in the capsule base 3, the said outlet opening being sealed by the film or foil 108 in the starting state. In this case, the film or foil 108 preferably has a pull-off tab 109 for pulling off the film or foil 108 by hand. The capsule base 3 is not perforated by means of an external perforation means 16. Instead, when the portion capsule 1 is inserted into the brewing chamber 8, the film or foil 108 is simply pulled off from the capsule base 3 by means of the pull-off tab 109 and the brewing process can then be started directly and without perforation of the capsule base 3. However, it is also possible for the film or foil 108 to remain on the portion capsule and to be pierced by the perforation means. The filter element spans the outlet opening 108 which is preferably of such a size that it exhibits no appreciable pressure loss of the outflowing beverage even when the perforation means is located in the opening. It is clear to a person skilled in the art that the outlet opening can also be sealed off by a film or foil which does not have a pull-off tab and/or which is connected to the capsule base such that it cannot be peeled off.

A person skilled in the art recognizes that it is possible for the perforation means 16, when it enters the capsule, to stretch, tap and/or pierce the filter element, that is to say it is possible, for example, for the filter element to be cohesively connected to the base of the capsule at least in sections, to be intended to bear against the base over as large an area as possible and/or to be stretched.

FIGS. 7 and 8 show a further embodiment of the present invention. In the present case, the filter element 7 is designed such that the perforation means 16, when it penetrates the capsule, stretches, taps (FIG. 10) and/or pierces the filter element, that is to say the filter element is cohesively connected, for example, to the base of the capsule at least in sections, is intended to bear against the base over as large an area as possible and/or is stretched.

FIGS. 9a-c show different embodiments of a filter element 7 with a felt structure 7.1, in particular a needle felt structure. This filter element 7 preferably has a support structure 7.2, for example a woven structure. A felt structure 7.1 is arranged on and/or in this woven structure 7.2 over the entire surface which faces the coffee powder or tea, and for example is connected to the said woven structure by needle felting, as illustrated in FIG. 9a. The embodiment according to FIG. 9b has two felt structures 7.1 and 7.3 which are each arranged on and/or in the support structure. The two structures preferably extend over the entire cross section, that is to say, in this case, the entire circular surface, of the filter element. The felt structures 7.1 and 7.3 can be of identical or different thickness. The felt structure 7.1 is preferably thinner than the layer 7.3, or vice verse. The support layer is thus offset in relation to the centre, based on the thickness, of the filter element. The structures 7.1 and 7.3 can be produced from different materials or the same material. These relate not only to the substance from which they are produced but also the thread diameter and/or the thread length from which the felt structures are manufactured. A support structure 7.2 is provided between the two structures 7.1 and 7.3, the said support structure not containing a felt structure or only a small felt structure and preferably permitting transverse flow. FIG. 9c shows yet another embodiment of a filter element with a felt structure. In the present case, two filter elements 7 with a felt structure are arranged one above the other, as has been described, for example, according to FIGS. 9a and b. The filter elements 7 can only lie one on the other or be connected to one another. However, the filter elements 7 can also comprise only felt, without a support structure.

All filter elements with a felt structure have the advantage that they exhibit a low level of pressure loss and that the pressure falls along the filter element with a shallow gradient. As a result, coffee without crema, that is to say foam, or tea without foam can be produced for example. The filter elements with a felt structure are preferably inserted only into the capsule. The filter element with the felt structure preferably has a larger diameter than the base of the capsule, and therefore it presses against the wall of the capsule in the edge region.

The filter element with a felt structure is preferably produced from PET, in particular completely.

At least one of the felt structures 7.1 and/or 7.3 is spot- and/or structure-calendered. This increases the strength of the filter element 7. The entire filter element is preferably routed through two rollers and calendered in the process.

A preferred embodiment of the present invention is illustrated in FIG. 10. In this case, the fibre material 24, from which the filter element 7 is produced, has two layers 7.5, 7.6 which are preferably produced independently of one another and then connected to one another along the connecting area(s) 26. However, the fibre material can also be produced in one layer and then split or folded in order to obtain several layers which are then connected to one another. In the present case, each connecting area is a strip which is narrow in relation to the width B of the fibre material or of the filter element 7 and of which the width is in each case preferably less than 30%, particularly preferably less than 20%, further preferably less than 10%, and at most preferably less than 5%, of the width B of the filter element 7. This type of preferred embodiments has the advantage that the two layers 7.5, 7.6 of the filter element 7 which is cut, in particular stamped, out of the fibre material are connected to one another but nevertheless can move relative to one another. As an alternative or in addition, the layers can also be connected to one another with patterns other than those described above. By way of example, the said layers can be connected to one another by two intersecting lines, in particular straight lines.

The layers can be of identical or different construction. This applies, for example, in respect of the material, the size, thickness and/or the structure of the respective layer. It is even possible to combine a filter layer with a non-woven layer. There may be more than two layers.

By way of example, a perforation means 16 which taps the capsule can pierce the second layer 7.6 and lift off the first layer 7.5 from the second layer 7.6, this being illustrated in FIG. 11. However, it is also possible for the perforation means to raise both layers.

### LIST OF REFERENCE SYMBOLS

1 Portion capsule
2 Capsule body
3 Capsule base
3a Inner side of the capsule base
3′ Edge region of the capsule base
4 Filling side
5 Collar edge
6 Cover film or foil
7 Filter element
7′ Edge region of the filter element
7″ Central region of the filter element
7.1 Felt structure, needle felt structure
7.2 Support structure
7.3 Felt structure, needle felt structure
7.4 Spot-calendered portion
7.5 First layer
7.6 Second layer
8 Brewing chamber
9 First brewing chamber element
10 Second brewing chamber element
11 Seal
12 Closing piston
13a Puncturing element
13b Puncturing element
14 Preparation liquid supply means
15 Brewing bell
16 Opening mandrel
17 Discharge grooves
18 Discharge means
19 Puncturing spike
20 Recess
21 Protrusion
22 Preparation liquid flow
23 Brewing bell base
24 Spot- and/or structure-calendered fibre material
25 Stamped-out ring, stamped-out contour, contour of the filter element
26 Connecting area between layers 7.5 and 7.6
100 Cavity
101 Beverage base
102 Side wall region
107 Outlet opening
108 Film or foil
109 Pull-off tab
B Width of the fibre material 24, width of the filter element 7

1. A portion capsule for producing a beverage, having a capsule body with a capsule base and a filling side, with a cavity for accommodating a pulverulent or liquid beverage base being formed between the capsule base and the filling side, and with a filter element being arranged between the beverage base and the capsule base, wherein the filter element elastic and provided at its circumference at a bottom of the capsule or at a side wall of the capsule.

2. The portion capsule according to claim 1, wherein the filter element is a spot- and/or structure-calendered non-woven or a spot- and/or structure-calendered felt.

3. The portion capsule according to claim 1, wherein at least some of the fibers are plastic fibers.

4. The portion capsule according to claim 1, wherein the filter element has a large number of spot-like recesses.

5. The portion capsule according to claim 2, wherein the filter element is the spot- and/or structure-calendered non-woven, and the non-woven comprises a non-woven material which is produced from fine polyester fibers, and/or in that the non-woven has a mass per unit area of between about 40 and about 250 grams per square meter, and/or wherein the non-woven has a thickness of between about 0.2 and about 2.0 millimetres, and/or wherein the non-woven has an air permeability of between about 100 and about 3000 l/(m²s) at a pressure of 100 pascal.

6. The portion capsule according to claim 2, wherein the filter element comprises the spot- and/or structure-calendered felt structure that is a needle felt structure, which is provided on or in a support structure, with the filter element arranged in a region of the capsule base.

7. The portion capsule according to claim 6, wherein the filter element has two needle felt structures, which are separated from one another by a support structure and of which at least one is spot- and/or structure-calendered.

8. The portion capsule according to claim 1, wherein the filter element is connected to the capsule base by cohesive connection.

9. The portion capsule according to claim 8, wherein the cohesive connection is provided locally in a form of a circular ring.

10. The portion capsule according to claim 8, wherein the filter element is ultrasonically sealed and stretched.

11. The portion capsule according to claim 1, wherein the filter element completely or only partially covers the capsule base.

12. The portion capsule according to claim 1, the capsule base has a protrusion in a direction opposing the filling side.

13. The portion capsule according to claim 1, wherein the filter element is formed in such a way that, when the capsule base is penetrated by an external perforation means, the filter element is at least partially lifted off from the capsule base.

14. The portion capsule according to claim 13, wherein the filter element lifts off from the capsule base only in a central region and continues to rest on the capsule base or remains attached to the capsule base in an edge region of the capsule base.

15. The portion capsule according to claim 1, wherein the filter element is formed and attached to the capsule base in such a way that, when the capsule base is penetrated by an external perforation means, the filter element is tapped and/or pierced.

16. The portion capsule according to claim 1, wherein the capsule base has an outlet opening which is sealed off by a film or foil, with the film or foil having a pull-off tab for pulling off the film or foil by hand.

17. The portion capsule according to claim 16, wherein the filter element spans the outlet opening.

18. The portion capsule according to claim 1, wherein the filter element has a plurality of layers.

19. The portion capsule according to claim 18, wherein the layers are connected to one another only in a subregion.

20. The portion capsule according to claim 18, wherein the layers are provided in one piece or several pieces.

21. The portion capsule according to claim 18, wherein, when the capsule is opened, one layer is tapped or pierced by a perforation means.

22. The portion capsule according to claim 1, wherein the beverage base is Camellia sinensis which is treated with an acid.

23. Use of a portion capsule according to claim 1 for producing a coffee, cocoa, tea and/or milk beverage and/or other beverage preparations.
